(19) United States
(12) Patent Application Publication
(10) Pub. No.: US 2026/0268114 A1
(43) Pub. Date: Sep. 10, 2026

(54) GRAPH-GROUNDED LLMS LEVERAGING GRAPHICAL FUNCTION CALLING TO MINIMIZE LLM HALLUCINATIONS

(71) Applicant: Honda Motor Co., Ltd., Tokyo (JP)

(72) Inventors: Piyush GUPTA, San Jose, CA (US); Sangjae BAE, San Jose, CA (US); David ISELE, Sunnyvale, CA (US)

(73) Assignee: Honda Motor Co., Ltd., Tokyo (JP)

(21) Appl. No.: 19/296,420

(22) Filed: Aug. 11, 2025

Related U.S. Application Data
(60) Provisional application No. 63/767,698, filed on Mar. 6, 2025.

(51) Int. Cl. G06N 3/042; G06N 3/0475

(52) U.S. Cl. CPC G06N 3/042; G06N 3/0475

(57) ABSTRACT

A graph-grounded large language model (LLM) may have an LLM. A graph library may be coupled to an input of the LLM. The graph library may store a plurality of graph functions. Each graph function may have a JSON formatted description. Computed outputs from the LLM may be returned to the LLM for additional processing.

### RELATED APPLICATIONS

This patent application is related to U.S. Provisional Application No. 63/767,698 filed Mar. 6, 2025, entitled “Graph-Grounded LLMs: Leveraging Graphical Function Calling to Minimize LLM Hallucinations”, in the names of the same inventors which is incorporated herein by reference in its entirety. The present patent application claims the benefit under 35 U.S.C § 119(e) of the aforementioned provisional application.

### BACKGROUND

In recent years, Large Language Models (LLMs) have gained traction and found applications across a broad spectrum of tasks that may extend well beyond traditional text completion. These applications may include multi-robot task planning, autonomous driving, human robot interactions, structured commonsense reasoning, and knowledge probing. Despite LLMs performance in tasks that may require common sense reasoning, LLMs may continue to face challenges such as hallucinations and mathematical inaccuracies. These challenges may hinder LLMs deployment in real-world applications.

Parallel to these developments, researchers may be exploring the use of LLMs for tasks involving implicit graph structures. Graphs may be foundational in engineering, as the graphs may simplify complex problems through visual representations and the principles of graph theory, may serve as memory-efficient data structures, and may benefit from optimized algorithms that may enhance problem-solving capabilities. Robust graph reasoning and efficient operations may be important in diverse applications, from knowledge and social networks to motion planning. Using LLMs to reliably and accurately tackle graph related challenges may unlock LLMs full potential in addressing engineering and robotics problems.

In the past, researchers have examined how LLMs may convert high-level instructions into concrete actions within structured synthetic environments. Researchers may have developed methods to continuously update and maintain structured world representations as states evolve, thereby facilitating operations in interactive, real-world settings. For structured commonsense reasoning, LLMs may be provided with natural language inputs and may be tasked with producing graphs—such as event graphs, reasoning graphs, or argument explanation graphs—that may encapsulate the underlying relationships. In the domain of knowledge probing, LLMs may uncover implicit connections and pathways among a broad network of entities and concepts. Furthermore, the potential of LLMs in performing graph node classification may be investigated. Researchers have leveraged swarm intelligence which may be used to solve graph reasoning problems by assigning an LLM-agent to each node, allowing it to focus on processing its own information and communicate with neighbors. Lastly, in multi-robot mission planning, LLMs may be utilized to construct hierarchical tree representations of missions, which may aid in devising individual plans for each robot. Collectively, these studies may underscore the growing trend of employing LLMs for tasks and environments characterized by implicit graphs and structured representations.

Despite advances that may have improved LLM performance in graphical tasks, several questions may remain about LLMs ability to effectively handle graph-related problems. For example, it may be questionable whether LLMs can explicitly interpret textual descriptions of graphs, map them onto grounded conceptual spaces, and execute structured operations on these representations? Early research in this domain may indicate that while LLMs may demonstrate preliminary graph reasoning abilities, LLMs performance may deteriorate as problem complexity increases. Additionally, LLMs may be prone to brittle failures when confronted with spurious correlations. Further, the advantages of prompting and in-context learning may diminish as graph-based challenges become more intricate.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a graph-grounded large language model (LLM) is provided. The graph-grounded LLM may have an LLM. A graph library may be coupled to an input of the LLM storing a plurality of graph functions. Each graph function may have a JSON formatted description. Computed outputs from the LLM may be returned to the LLM for additional processing.

According to an embodiment of the disclosure, a graph-grounded large language model (LLM) is provided. The graph-grounded LLM may have a graph library storing a plurality of graph functions. Each graph function may have a JSON formatted description. An LLM may be coupled to the graph library, wherein the LLM processes a problem through a step-by-step process engaging graph functions when needed. A function manager may be coupled to the LLM and the graph library. The function manager may execute a selected function cell storing a corresponding graph function and may send a computed output of the selected function cell to the LLM when requested by the LLM. Computed outputs from the LLM may be returned to the LLM for additional processing.

According to an embodiment of the disclosure, a graph-grounded large language model (LLM) is provided. The graph-grounded LLM may have a graph library storing a plurality of graph functions, each graph function having a JSON formatted description. The JSON formatted description may have information as to a purpose for each graph function, arguments of each graph function, and data type of each graph function. The plurality of graph functions may be graph construction, graph manipulation, computing shortest distances and paths, topological sorting, maximum flow computation, identifying connected components, and graph visualization. An LLM may be coupled to the graph library, wherein the LLM processes a problem through a step-by-step process engaging graph functions when needed. A function manager may be coupled to the LLM and the graph library, wherein the function manager executes a selected function cell storing a corresponding graph function and sends a computed output of the selected function cell to the LLM when requested by the LLM. User-defined functions may enable the LLM to analyze and refine outputs of the LLM, wherein computed outputs from the LLM are returned to the LLM for additional processing.

### BRIEF DESCRIPTION OF THE DRAWINGS

FIG. 1 is a block diagram of an exemplary graph-grounded LLM, in accordance with an embodiment of the disclosure;

FIG. 2 is a text file of an exemplary JavaScript Object Notation (JSON) formatted description for the graph-grounded LLM, in accordance with an embodiment of the disclosure.

FIG. 3 displays an exemplary comparison between a stand-alone LLM and the graph-grounded LLM, in accordance with an embodiment of the disclosure.

FIG. 4 displays an exemplary comparison between a stand-alone LLM and the graph-grounded LLM, in accordance with an embodiment of the disclosure.

FIG. 5 displays an exemplary graph-related tasks of varying complexity, each accompanied by sample natural language prompts used with LLMs, in accordance with an embodiment of the disclosure.

FIG. 6 displays a diagram of an exemplary disaster response application for the graph-grounded LLM to act as a natural language decision support system for the disaster response mission, in accordance with an embodiment of the disclosure.

FIG. 7 displays an exemplary graph-grounded LLM acting as a natural language decision support system for the disaster response mission, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The present disclosure provides graph-grounded LLMs, a system that may improve LLMs performance on graph-related tasks by integrating a graph library through function calls. By grounding LLMs in this manner, reductions in hallucinations and improved mathematical accuracy in solving graph-based problems may be demonstrated, as evidenced by the performance on the NLGraph benchmark. Finally, a disaster rescue application may be shown where the graph-grounded LLM may acts as a decision-support system.

Reference will now be made in detail to specific aspects or features, examples of which are illustrated in the accompanying drawings. Wherever possible, corresponding, or similar reference numbers will be used throughout the drawings to refer to the same or corresponding parts.

The adoption of LLMs may be rapidly expanding across various tasks that involve inherent graphical structures. Graphs may be integral to a wide range of applications, including motion planning for autonomous vehicles, social networks, scene understanding, and knowledge graphs. Many issues, even those not initially perceived as graph-based, may be effectively addressed through graph theory. However, when applied to these tasks, LLMs may often encounter challenges, such as hallucinations and mathematical inaccuracies. Given these limitations, a hybrid approach may be warranted.

LLMs may be utilized for high-level reasoning, while computationally intensive mathematical operations may be best handled by traditional software, particularly with the availability of efficient graph libraries. This approach may reduce the computational burden on LLMs, enhancing both reliability and accuracy in solving graph-related problems.

To address the above challenges, graph-grounded LLMs may be proposed, a system that may combine a graph library with the function-calling capabilities of LLMs to reduce hallucinations in graph-related tasks. The function-calling feature may increasingly gain traction for leveraging large-scale Application Programming Interfaces (APIs) to enhance LLM accuracy across various domains. Unlike previous approaches, the present method may employ multiple rounds of closed-loop function calling, enabling the LLM to iteratively construct graphs and execute graphical operations to logically and robustly solve implicit graph problems with high accuracy across diverse domains.

The present system and methodology differ from prior works in the following manner. First, the present system and method uses graph-grounded LLMs, a system that may integrate a graph library with the function-calling capabilities of LLMs to minimize hallucinations in graph-related tasks. Second, the system and method have been evaluated using the NLGraph benchmark, which may demonstrate near 100% accuracy on most tasks while analyzing less successful cases to highlight areas for improvement. Third, a disaster response application may be shown where the graph-grounded LLM may act as a natural language decision-support system, gathering environmental data, mapping the scenario to a graph problem, assisting in response planning, answering scenario-related queries, and facilitating dynamic re-planning.

Recent advances in LLMs may enhance LLMs performance in tasks with implicit graph structures. However, despite the preliminary graph reasoning ability of the LLMs, LLMs may suffer from hallucinations (fact alteration), mathematical inaccuracies, and non-repeatability of solutions, which may limit LLMs usage in real-world applications. To this end, the below presents graph-grounded LLMs, a system that may leverage the function calling ability of the LLMs with a user-built graph library which may reduce the computational overhead of the LLMs in graph related tasks. The following may be some of the advantages offered by the graph-grounded LLMs:
Leveraging Pre-existing Libraries: Efficient graph libraries such as networkx may enable easy development of user-defined functions, allowing use of optimized algorithms and software for improved performance.
Task-Agnostic Graph Library: A user-built library may be designed as a general-purpose toolset, independent of specific tasks. This may allow LLMs to flexibly utilize a broad range of graph operations to solve diverse problems.
Reduced LLM Overhead: Since the graph computations may be handled externally, the LLM does not need to track all context and intermediate steps. This may minimize reliance on memorization, enhance accuracy, and reduces computational burden.
Scalability to Larger Graphs: While LLMs may struggle with increasing problem size, traditional graph processing libraries may efficiently handle large graphs. By offloading computations, graph-grounded LLMs may maintain high accuracy even for complex, large-scale tasks.
Robust Edge-Case Handling: User-defined functions may enable explicit handling of both inherent problem edge cases and those introduced by LLMs, which may enhance the reliability of graph-grounded LLMs. For instance, if an LLM mistakenly generates a directed graph instead of an undirected one, a function requiring an undirected graph can internally convert it, ensuring correctness without requiring LLM correction.
Error-Guided Self-Correction: LLMs may be prone to hallucinations, which may lead to incorrect responses. By incorporating structured error handling in user-defined functions, LLMs may self-reflect and refine their outputs. For instance, if a bipartite graph function returns an error on a non-bipartite graph, the LLM may correct its approach by regenerating a valid bipartite graph.

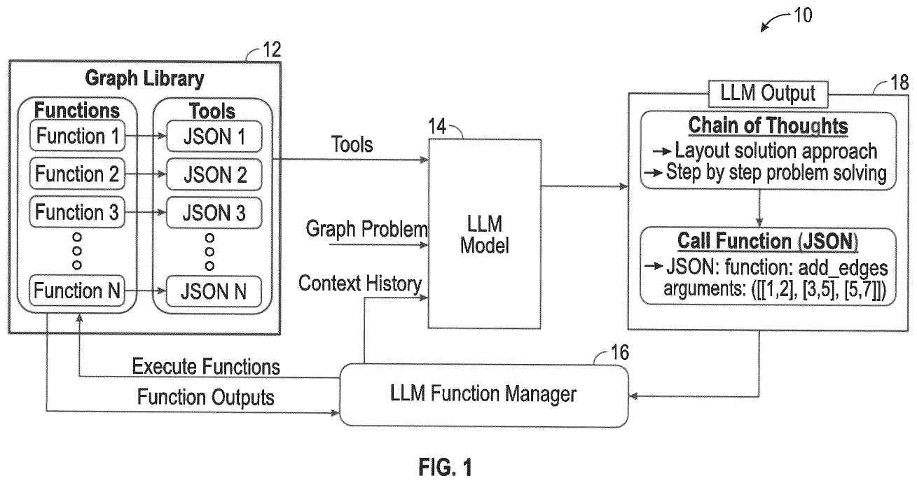

FIG. 1 may show a schematic of the graph-grounded LLM 10. The framework may include a user-built graph library 12. The graph library 12 may containing various graph functions, each accompanied by a JavaScript Object Notation (JSON)-formatted description. These JSON descriptions may be provided to the LLM 14 as tools, along with the context and user-specified graph problem. This setup may enable the LLM 14 to comprehend the available graph functions and their operations.

The graph library 12 may be designed to address both inherent and LLM-induced edge cases. 0-chain-of-thought reasoning approach may be employed, where the LLM 14 may be prompted to think step-by-step through the problem, invoking graph functions as needed via function calls. Once a solution strategy is formulated, the LLM 14 may determine the required function calls, which may be executed by the function manager 16. The computed outputs 18 may then returned to the LLM 14 for further reasoning and problem-solving.

In this approach, a graph may be explicitly constructed, and all requested operations may be performed systematically, ensuring accuracy. The process may involve multiple rounds of closed-loop function requests and executions before the LLM 14 arrives at the final solution. Additionally, built-in error checking and handling within the graph library 12 may enable the LLM 14 to self-reflect and self-correct its graph construction and function requests in case of mistakes.

The graph library 12 may be designed with commonly used graph functions, enabling the graph-grounded LLM 10 to handle a wide range of graph-related tasks. In accordance with one example, 29 commonly used graph functions may be used to enable the graph-grounded LLM 10 to handle a wide range of graph-related tasks. The graph library 12 may be task-agnostic, featuring a general-purpose toolset for graph construction and operations. Key functions may include graph construction (directed/undirected, weighted/unweighted), adding nodes and edges, computing shortest distances and paths, topological sorting, maximum flow computation, and identifying connected components, among others. Internally, these functions may leverage the efficient networkx library for implementation. Additionally, the graph library 12 may be built with robust error handling and edge-case considerations, allowing the LLM 14 to self-reflect and self-correct its mistakes, improving reliability and performance.

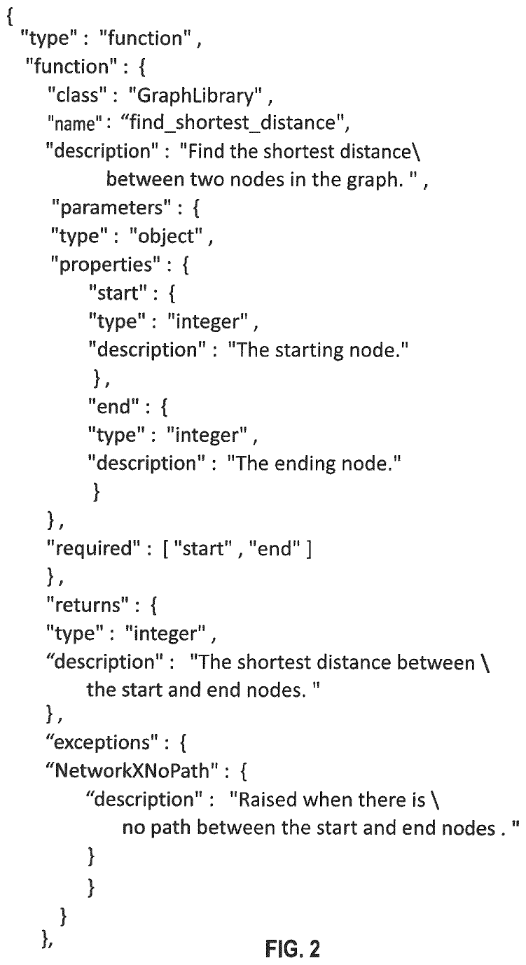

For each function in the graph library 12, JSON description may be created that may include details such as the function's purpose, its arguments, and their respective data types. This structured representation may help the LLM 14 understand the function's utility and may ensure the LLM 14 generates arguments with the correct data types. FIG. 2 may show an example JSON description of the find shortest path function. Simple function descriptions should be sufficient for the LLM 14 to grasp the function's utility.

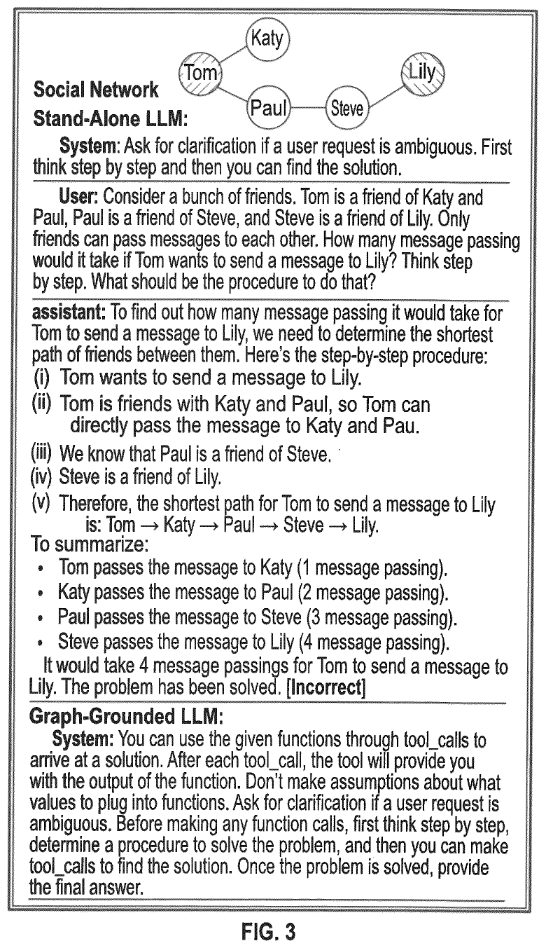

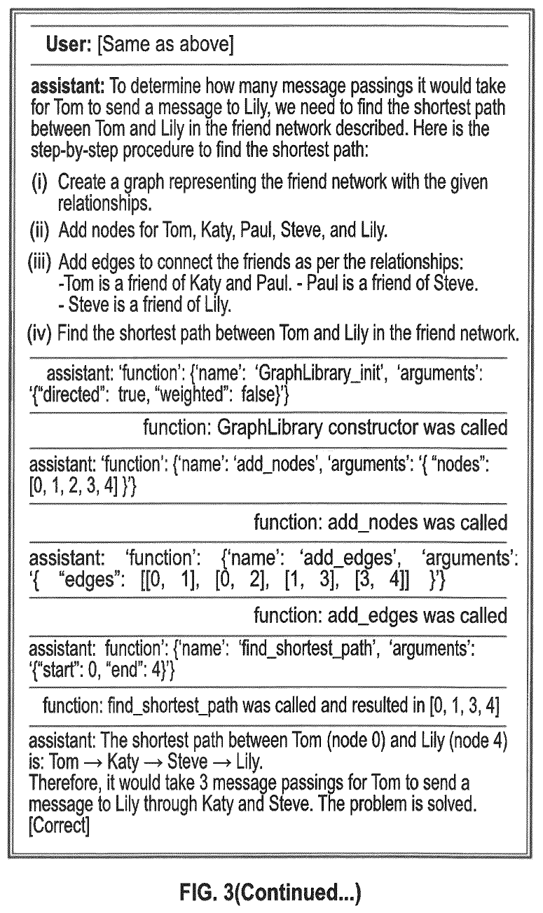

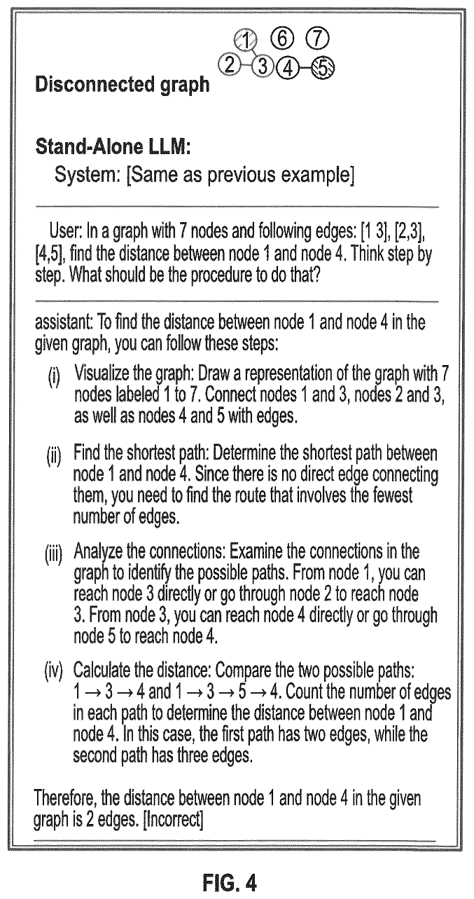

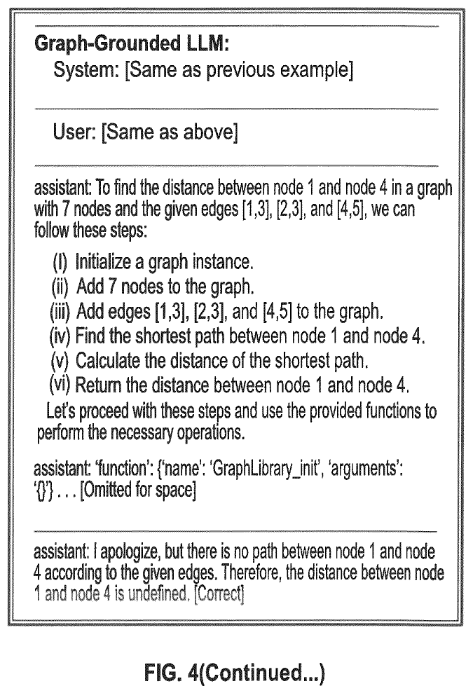

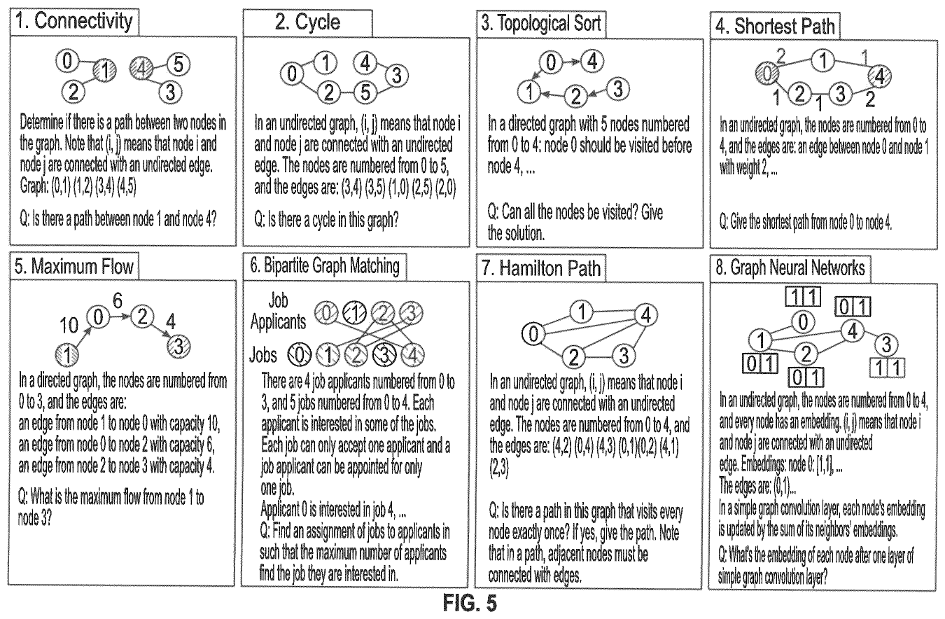

FIGS. 3 and 4 may show two motivating examples using the gpt-3.5-turbo-0125 model, highlighting cases where the standalone LLM produces incorrect answers, while graph-grounded LLMs 10 may effectively utilize function calls to construct the relevant graph, execute appropriate graph operations, and logically derive the correct solution. FIG. 3 may use LLMs to find out how many message passings it would take for one party to send a message to another party by determining the shortest path between the parties. FIG. 4 may use LLMs to find the distance between two nodes. These motivating examples may illustrate the advantages of graph-grounded LLMs 10 over stand-alone LLMs for graph-related tasks.

The performance of graph-grounded LLM 10 on the NLGraph benchmark may be evaluated, which may include 6,022 problems spanning eight distinct graph reasoning tasks. The dataset may feature problems of varying difficulty, with factors such as graph size, network sparsity, and numeric range influencing complexity. Consequently, some tasks may be divided into easy, medium, and hard subsets, while others may be categorized into easy and hard levels. The eight task categories in the benchmark may include:
1. Connectivity: In this task, the LLM may determine whether two given nodes u∈V and v∈V in an undirected graph G={V, E} are connected.
2. Cycle: In this task, the LLM may determine whether there exists a cycle in an undirected graph G={V, E}.
3. Topological Sort: In this task, the LLM may be required to produce a valid topological ordering based on a set of node order constraints. Since multiple correct solutions may exist, an external program may be used to verify the validity of the ordering generated by the LLM.
4. Shortest Path: In this task, the LLM may determine the shortest path between two given nodes u∈V and v∈V in an undirected graph G={V, E} along with the path length.
5. Maximum Flow: In this task, the LLM may generate a routing plan to maximize the flow from the source node s∈V to the sink node t∈V in a graph G={V, E}. Each edge e∈E may be associated with a capacity c, representing the maximum flow it can carry.
6. Bipartite Graph Matching: In this task, the LLM may be provided with a list of job applicants, each interested in a subset of available jobs, and may be tasked with determining a maximum matching between the applicants and the jobs. In graph theory, this may equate to finding a maximum matching in a bipartite graph, identifying a set of edges with no common nodes that maximizes the total number of matches. An external program may be employed to verify both the validity and optimality of the LLM's solution.
7. Hamilton Path: In this task, the LLM may be tasked with finding a valid Hamilton path in an undirected graph G={V, E}. A Hamilton path is one that may visit every node exactly once, and an external program may be used to verify the correctness of the LLM's solution.
8. Graph Neural Network (GNN): In this task, given an undirected graph G={V, E} and a two-dimensional embedding xᵢ for each node, the LLM may perform l layers of message passing. At each layer, a node's embedding may be updated by summing the embeddings of all its neighboring nodes.

An overview of the NLGraph benchmark tasks may be shown in FIG. 5. The illustration may present the eight graph-related tasks of varying complexity, each accompanied by sample natural language prompts used with LLMs.

The evaluation results on the eight different graph reasoning tasks in the NLGraph benchmark above may be evaluated below. Table I may compare the performance of a standalone LLM with that of a graph-grounded LLM 10 on these tasks. The average computation time for the graph-grounded LLM 10 may be generally higher than that of a stand-alone LLM due to multiple rounds of closed-loop function calls. Notably, some problems may exhibit significantly longer computation times than others. To provide a more representative measure, average computation times may be reported after rejecting these outliers in computation time. For all evaluations, the gpt-4-0613 model may be used as the chosen LLM.

TABLE I
Performance on the NLGraph benchmark

| | | | | | | Graph- |
|---|---|---|---|---|---|---|
| | | | | Stand-Alone | Graph- | Grounded |
| | | | Stand-Alone | LLM | Grounded | LLM |
| | | Number | LMM | (Average | LLM | (Average |
| Task | Difficulty | of Tasks | (Correct) | Time in s) | (Correct) | Time in s) |
| Connectivity | Easy | 352 | 346 (98.30%) | 2.89 | 352 (100.00%) | 11.68 |
| Connectivity | Medium | 1200 | 1131 (94.25%) | 3.30 | 1200 (100.00%) | 11.81 |
| Connectivity | Hard | 680 | 628 (92.35%) | 4.61 | 680 (100.00%) | 18.06 |
| Cycle | Easy | 150 | 89 (59.33%) | 7.16 | 149 (99.33%) | 12.39 |
| Cycle | Medium | 600 | 347 (57.83%) | 12.10 | 600 (100.00%) | 14.01 |
| Cycle | Hard | 400 | 206 (51.50%) | 13.28 | 400 (100.00%) | 19.62 |
| Topological | Easy | 180 | 42 (23.33%) | 7.96 | 143 (79.44%) | 14.76 |
| sort | | | | | | |
| Topological | Medium | 450 | 4 (0.89%) | 14.69 | 343 (76.22%) | 21.05 |
| sort | | | | | | |
| Topological | Hard | 180 | 0 (0.00%) | 10.54 | 145 (80.56%) | 43.17 |
| sort | | | | | | |
| Shortest Path | Easy | 180 | 96 (53.33%) | 6.21 | 180 (100.00%) | 13.52 |
| Shortest Path | Hard | 200 | 48 (24.00%) | 10.55 | 200 (100.00%) | 16.01 |
| Maximum Flow | Easy | 150 | 25 (16.66%) | 7.84 | 149 (99.33%) | 13.06 |
| Maximum Flow | Hard | 200 | 10 (5.00%) | 11.39 | 196 (98.00%) | 23.79 |
| Bipartite | Easy | 300 | 219 (73.00%) | 6.22 | 297 (99.00%) | 28.32 |
| Matching | | | | | | |
| Bipartite | Hard | 210 | 121 (58.000%) | 17.73 | 204 (97.00%) | 45.67 |
| Matching | | | | | | |
| Hamilton Path | Easy | 150 | 48 (32.00%) | 7.44 | 150 (100.00%) | 15.15 |
| Hamilton Path | Hard | 200 | 17 (8.50%) | 11.44 | 200 (100.00%) | 17.01 |
| GNN | Easy | 100 | 81 (81.00%) | 11.43 | 100 (100.00%) | 16.85 |
| GNN | Hard | 140 | 61 (44%) | 22.04 | 140 (100%) | 21.46 |

Among the tasks, connectivity and cycle detection may be considered the easiest. The stand-alone LLM may achieve over 90% accuracy in the connectivity task and above 50% across the cycle tasks. In contrast, the graph-grounded LLM 10 may attain nearly 100% accuracy in both. For more complex tasks, such as the shortest path, Hamilton path, and Graph Neural Network evaluation, the graph-grounded LLM 10 may consistently achieve 100% accuracy, whereas the stand-alone LLM may perform significantly worse. Similarly, in the maximum flow and bipartite matching tasks, the stand-alone LLM exhibits much lower accuracy, while the Graph-rounded LLM 10 may achieve close to 100% accuracy.

The few observed issues may primarily stem from two factors: hallucinations caused by ambiguities in the problem prompt and the model exceeding its context limit (maximum context length for gpt-4-0613 model is 8,192 tokens) when handling extremely large graphs. The most notable drop in performance for the graph-grounded LLM 10 may occur in the topological sort task. This issue may be attributed to the original NLGraph problem prompt, which asks whether all nodes in a graph with multiple node order constraints can be visited. This phrasing may be similar to the Hamilton path problem, which seeks a path visiting each vertex exactly once. As a result, the LLM may sometimes incorrectly invoke the Hamilton path function instead of the topological sort function. Since the Hamilton path implementation may only apply to undirected graphs, this misinterpretation may lead to failures in cases where a directed acyclic graph may be provided.

To address this issue, the problem prompt for topological sorting may be modified from “Can all the nodes be visited?” to “Can all the nodes be visited in a valid topological order that satisfies these constraints?” Table II may present the updated performance results for this task with the revised prompt. With this adjustment, the graph-grounded LLM 10 may achieve nearly 100% accuracy on easy and medium tasks and 87.78% on hard tasks. The remaining failure cases primarily stem from exceeding the LLM's context length when processing extremely large graphs.

TABLE II
Improved performance in Topological Sort with the modified problem prompt

| | | | | | | Graph- |
|---|---|---|---|---|---|---|
| | | | | Stand-Alone | Graph- | Grounded |
| | | | Stand-Alone | LLM | Grounded | LLM |
| | | Number | LLM | (Average | LLM | (Average |
| Task | Difficulty | of Tasks | (Correct) | Time in s) | (Correct) | Time in s) |
| Topological | Easy | 180 | 87 (48.33%) | 5.39 | 179 (99.44%) | 15.36 |
| sort | | | | | | |
| Topological | Medium | 450 | 24 (5.33%) | 17.20 | 450 (100%) | 22.06 |
| sort | | | | | | |
| Topological | Hard | 180 | 0 (0.00%) | 10.50 | 158 (87.78%) | 40.85 |
| sort | | | | | | |

Remark 1: The Hamilton path task may belong to the class of NP-complete problems. As a result, one's backtracking implementation in the graph library may be highly inefficient and may require a significant amount of time to solve.

By analyzing the issue cases, the following conclusions may be derived:
1. Function Utilization Errors: In a single breakdown cycle task of easy difficulty, the graph-grounded LLM 10 may devise a correct solution strategy but may fail to utilize the available functions. Such rare breakdown may be mitigated by either restarting the task or employing self-consistency through majority voting.
2. Misuse of Similar Functions: When multiple similar functions exist in the graph library, the graph-grounded LLM 10 may select an unintended function due to the availability of multiple solution approaches. In such cases, the model may be highly sensitive to problem prompts, and clearer prompts may be necessary to ensure that the correct functions are used by the graph-grounded LLM 10.
3. Context Length Limitations: With a large number of available tools, extremely large problems may breakdown due to exceeding the graph-grounded LLM's context length. Scalability techniques such as Retrieval-Augmented Generation (RAG) may help manage tool selection efficiently in such scenarios.

Graph-grounded LLMs 10 may have broad applications in tasks involving implicit graph structures, such as inventory management, social networks, and multi-robot traffic management. In this work, a disaster response application may be explored where a graph-grounded LLM 10 may serve as a natural language decision-support system. To enhance its access to critical data from robot sensors and the environment, functions may be incorporated like get environment data, get environment map data etc.

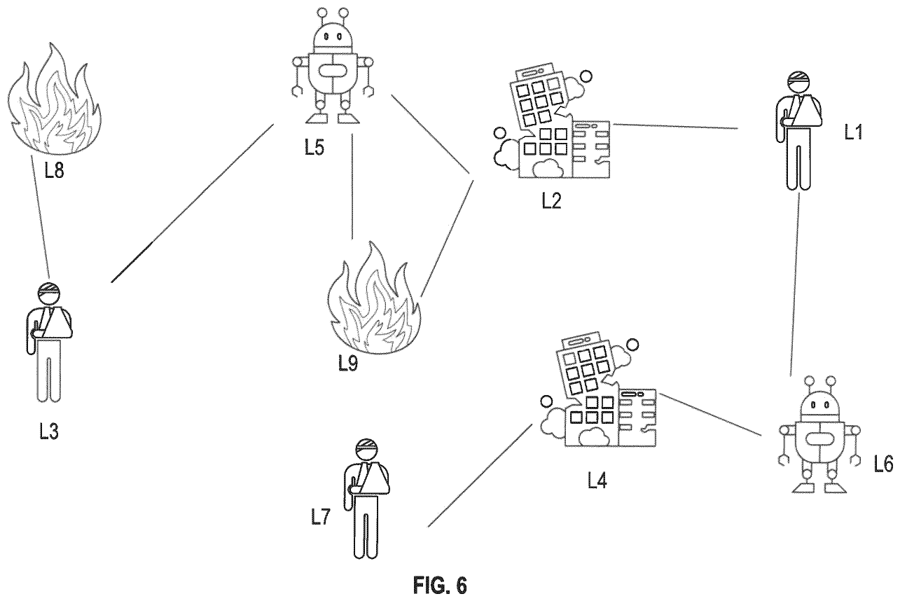

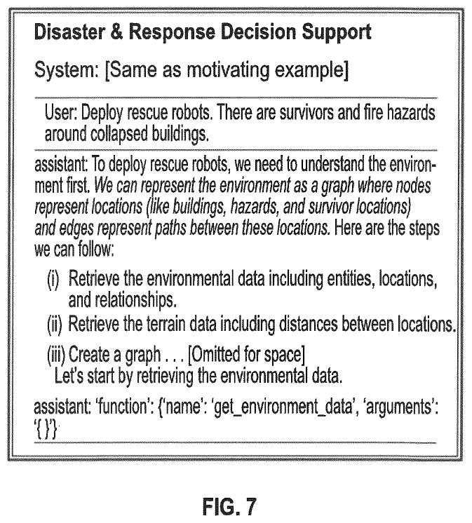

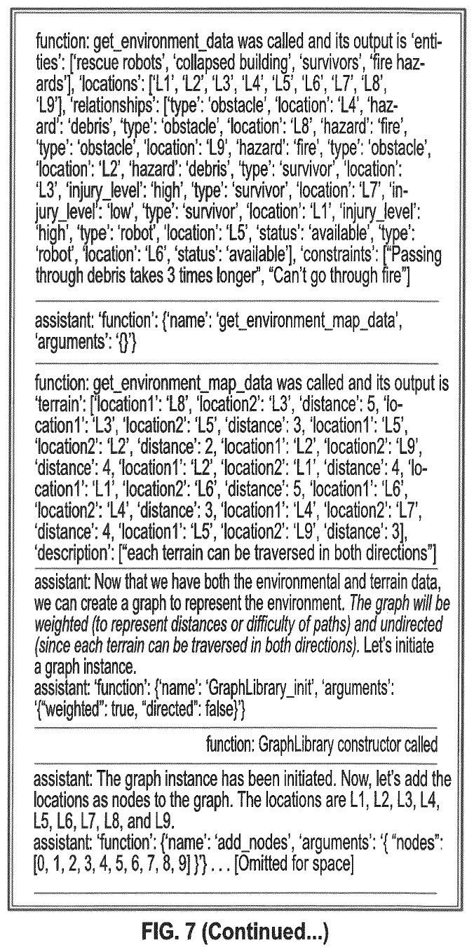

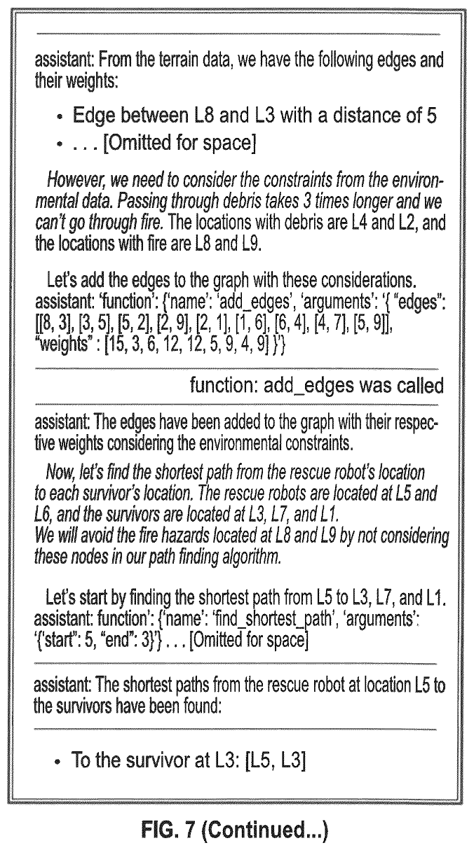

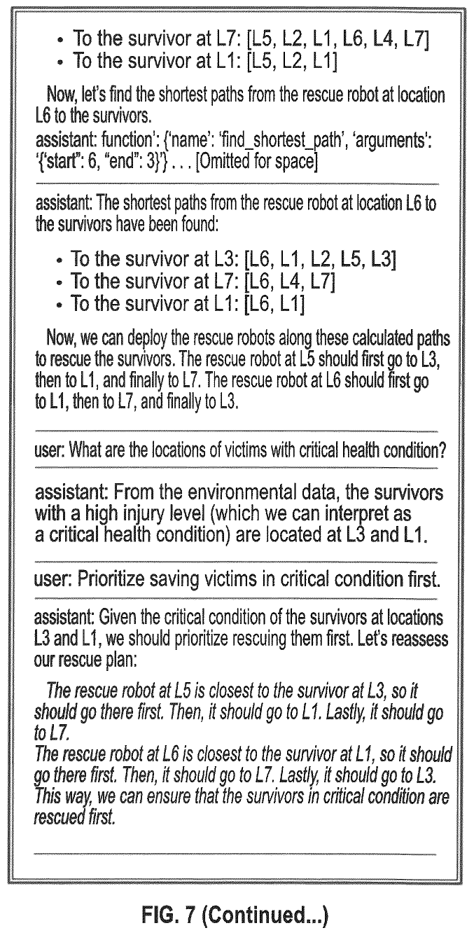

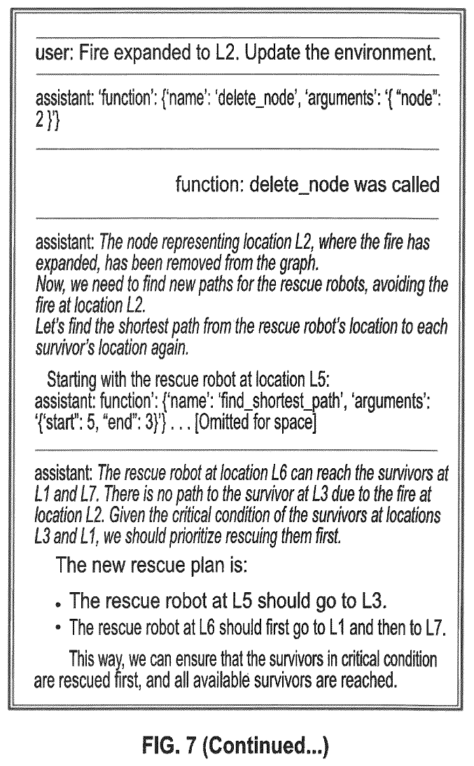

FIG. 6 may illustrate the disaster response application, featuring locations with collapsed buildings, fires, victims, and rescue robots. The graph-grounded LLM 10 may function as a natural language decision-support system, gathering environmental data, mapping the scenario to a graph problem, assisting in response planning, answering scenario-related queries, and facilitating dynamic re-planning as may be shown in FIG. 7.

Advancements in Large Language Models (LLMs) have expanded their applicability to tasks involving implicit graph structures. However, LLMs may struggle with hallucinations, mathematical inaccuracies, lack of repeatability, and performance degradation as problem complexity increases. To address these challenges, graph-grounded LLMs may be used such as a system that integrates a graph library with the function-calling capabilities of LLMs to enhance reliability in graph-related tasks. This approach may enable LLMs to solve implicit graph problems consistently and robustly, achieving nearly 100% accuracy across various domains in the NLGraph benchmark.

Graph-grounded LLMs may be enhanced through retrieval-augmented generation to dynamically select a relevant subset of tools based on the graph problem. Additionally, automated graph library modifications and function additions by the LLM may be investigated, enabling it to adapt and expand its capabilities over time.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiment disclosed, but that the present disclosure will include all embodiments that fall within the scope of the appended claims.

1. A graph-grounded large language model (LLM), comprising:
an LLM; and
a graph library coupled to an input of the LLM, the graph library storing a plurality of graph functions, each graph function having a JSON formatted description;
wherein computed outputs from the LLM are returned to the LLM for additional processing.

2. The graph-grounded LLM of claim 1, wherein the LLM processes a problem through a step-by-step process engaging graph functions when needed.

3. The graph-grounded LLM of claim 1, comprising a function manager coupled to the LLM and the graph library, wherein the function manager executes a selected function cell storing a corresponding graph function and sends a computed output of the selected function cell to the LLM.

4. The graph-grounded LLM of claim 1, wherein the graph library comprises a general-purpose toolset for graph construction and operations.

5. The graph-grounded LLM of claim 1, wherein the plurality of graph functions comprises graph construction, graph manipulation, computing shortest distances and paths, topological sorting, maximum flow computation, identifying connected components, and graph visualization.

6. The graph-grounded LLM of claim 1, wherein the graph library computes graph computations external of the LLM.

7. The graph-grounded LLM of claim 1, wherein the graph library is a task-agnostic graph library.

8. The graph-grounded LLM of claim 1, wherein the graph library comprises built-in error checking and handling enabling the LLM to self-correct graph construction and function requests.

9. The graph-grounded LLM of claim 1, comprising user-defined functions enabling the LLM to comprehend the graph functions and the graph functions operations.

10. The graph-grounded LLM of claim 1, comprising user-defined functions enabling the LLM to handle inherent problem edge cases and error cases introduced by the LLM.

11. The graph-grounded LLM of claim 1, comprising user-defined functions enabling the LLM to analyze and refine outputs of the LLM.

12. The graph-grounded LLM of claim 1, wherein the JSON formatted description comprises information as to a purpose for each graph function, arguments of each graph function, and data type of each graph function.

13. A graph-grounded large language model (LLM), comprising:
a graph library storing a plurality of graph functions, each graph function having a JSON formatted description;
an LLM coupled to the graph library, wherein the LLM processes a problem through a step-by-step process engaging graph functions when needed; and
a function manager coupled to the LLM and the graph library, wherein the function manager executes a selected function cell storing a corresponding graph function and sends a computed output of the selected function cell to the LLM when requested by the LLM;
wherein computed outputs from the LLM are returned to the LLM for additional processing.

14. The graph-grounded LLM of claim 13, wherein the plurality of graph functions comprises graph construction, graph manipulation, computing shortest distances and paths, topological sorting, maximum flow computation, identifying connected components, and graph visualization.

15. The graph-grounded LLM of claim 13, wherein the graph library computes graph computations external of the LLM.

16. The graph-grounded LLM of claim 13, wherein the graph library comprises built-in error checking and handling enabling the LLM to self-correct graph construction and function requests.

17. The graph-grounded LLM of claim 13, comprising user-defined functions enabling the LLM to handle inherent problem edge cases and error cases introduced by the LLM.

18. The graph-grounded LLM of claim 13, comprising user-defined functions enabling the LLM to analyze and refine outputs of the LLM.

19. The graph-grounded LLM of claim 13, wherein the JSON formatted description comprises information as to a purpose for each graph function, arguments of each graph function, and data type of each graph function.

20. A graph-grounded large language model (LLM), comprising:
a graph library storing a plurality of graph functions, each graph function having a JSON formatted description, wherein the JSON formatted description comprises information as to a purpose for each graph function, arguments of each graph function, and data type of each graph function, wherein the plurality of graph functions comprises graph construction, graph manipulation, computing shortest distances and paths, topological sorting, maximum flow computation, identifying connected components, and graph visualization;
an LLM coupled to the graph library, wherein the LLM processes a problem through a step-by-step process engaging graph functions when needed; and
a function manager coupled to the LLM and the graph library, wherein the function manager executes a selected function cell storing a corresponding graph function and sends a computed output of the selected function cell to the LLM when requested by the LLM; and
user-defined functions enabling the LLM to analyze and refine outputs of the LLM, wherein computed outputs from the LLM are returned to the LLM for additional processing.
